(19) United States
(12) Patent Application Publication
(10) Pub. No.: US 2013/0175853 A1
(43) Pub. Date: Jul. 11, 2013

(54) HOUSING ASSEMBLY WITH REED SWITCH AND MAGNET

(71) Applicants: Bradley D. Chamberlin, Pendleton, IN (US); Colin Hamer, Noblesville, IN (US); Cary Ramey, Greenwood, IN (US)

(72) Inventors: Bradley D. Chamberlin, Pendleton, IN (US); Colin Hamer, Noblesville, IN (US); Cary Ramey, Greenwood, IN (US)

(21) Appl. No.: 13/344,013

(22) Filed: Jan. 5, 2012

(51) Int. Cl. B60L 1/00; H02K 21/02

(52) U.S. Cl. 307/9.1; 310/71

(57) ABSTRACT

An electric machine and vehicular subsystem, apparatus includes a connection disposed within a housing and connecting a high voltage line with the electric machine. A controller controls the coupling of a power source to the high voltage line. A reed switch is positioned within the housing proximate the high voltage line connection. A member is removably mounted on the housing and structured so that removal of the member is necessary to gain access to the high voltage line connection, the member having a magnet. At least one low voltage communication line extends from the reed switch to the controller. Removal of the member from the housing opens the reed switch. Mounting of the member to the housing closes the reed switch. The controller terminates the providing of electric power to the high voltage line when the member is removed from the housing.

### BACKGROUND OF THE INVENTION

The invention relates generally to vehicular electrical systems and, more particularly, to an apparatus and system for reducing a danger of contact with high voltage present in a vehicle.

Electric vehicles are generally propelled by one or more electric or traction motors powered by electricity, alone or in combination with non-electric propulsion, for example, motive force provided by an internal combustion engine. A source of such electric power may be stored electricity, for example, from a battery bank, electricity generated within the vehicle, and/or electricity received from an external source, such as a trolley in electrical communication with overhead power lines.

In many applications, the designed performance characteristics of an electric vehicle can only be achieved by supplying dangerous high voltages to a drive system. Direct current (DC) voltage may be directly supplied to a DC motor or it may be converted to alternating current (AC) by an inverter circuit that supplies power to an AC motor. A generator of a vehicle may be configured to output either DC or AC voltage. Electric power line(s) supplying electricity to a motor of an electric vehicle may be variously arranged in series and/or parallel configurations. An on/off state of such electric power line(s) is typically controlled by one or more controllers.

One or more electric motors of an electric vehicle may be positioned in proximity to a transmission. In such a case, for example, an electric motor may be a cartridge type motor structured to be slidingly removable from a larger housing. For this and other configurations, a worker servicing the vehicle may have difficulty physically accessing the electric power lines, for example within a small engine compartment of a passenger car.

In order to reduce a danger of injury to those in proximity to dangerous high voltage(s) of an electric vehicle, an interlock has been conventionally used to cause a controller to decouple such high voltage(s). The controller may be an electronic control unit powered by a low voltage obtained from a vehicle battery and structured for sending/obtaining low voltage signals to/from various locations of the vehicle. In one common form, a mechanical limit switch is secured within a metal housing so that a protruding portion of a housing cover engages an arm of the limit switch. When the cover is mounted to the housing, the protruding portion engages the arm and the contacts of the limit switch are thereby closed, which causes the controller to provide electricity to the power lines. Many different variations exist for removing or applying a high voltage to power lines of an electric vehicle. For example, a connection or disconnection may include, but are not limited to, mechanical, electrical, semiconductor, inductive, and other structures for applying or removing a voltage. When the cover is removed, the protruding portion is pulled away from its engagement with the arm and the contacts of the limit switch are thereby opened, which causes the controller to disable the provision of electricity to the power lines. A strong supporting structure is required for mounting the limit switch. The wiring to the limit switch may necessitate the use of an additional connector which further reduces available servicing space within an engine compartment. For example, such a supporting structure may be a separate, heavy-duty limit switch housing having an electrical connector formed of heavy gauge metal mounted thereon. Such limit switches and associated installations are costly, heavy, bulky, difficult to install/remove, and are subject to contamination, heat, vibration, and related reliability issues.

With respect to reducing a danger of injury to persons working near dangerous high voltage(s) of an electric vehicle, conventional interlock devices and systems are not optimized for service, repair, or manufacturing of electric vehicles.

### SUMMARY

The subject invention provides a vehicular subsystem and electric machine that simplify and make safer a servicing or repair operation being performed near high voltage lines of an electric vehicle. Similarly, a manufacturing cost for time and materials is reduced.

In one embodiment, a vehicular subsystem is provided for use in a vehicle having at least one wheel, the vehicular subsystem having a housing and an electric machine operably coupled with the wheel and positioned within the housing. A power source provides electric power to the electric machine via at least one high voltage line. A connection is disposed within the housing of the electric machine and connects the high voltage line with the electric machine. A controller is controllably coupled to the power source. A reed switch is positioned within the housing proximate the high voltage line connection. A member has a magnet and is removably mounted on the housing and structured so that removal of the member is necessary to gain access to the high voltage line connection. At least one low voltage communication line extends from the reed switch to the controller. According to this aspect, removal of the member from the housing opens the reed switch, mounting of the member to the housing closes the reed switch, and the controller disconnects the electric power when the member is removed from the housing.

In another embodiment, an electric machine is provided that has a housing, an electric motor disposed in the housing, a terminal block disposed within an interior portion of the housing and having a terminal structured for securing a corresponding at least one high voltage cable thereto, at least one access port formed in the housing and structured to provide access to the terminal, at least one reed switch disposed within the housing at a location proximate the access port, a control connector mounted on the housing and in communication with the reed switch, at least one communication line in electrical communication with the reed switch, and at least one access port plug having a magnet, the access port plug closing the reed switch when the access port plug is installed in the access port, the access port plug opening the reed switch when removed from the access port. The communication line is in communication with the control connector, whereby an external controller can be placed in communication with the reed switch.

In yet another embodiment, an electric machine is provided that has a housing, an electric motor/generator disposed in the housing, a terminal block disposed within an interior portion of the housing and having a plurality of terminals structured for securing a corresponding plurality of high voltage cables thereto, a plurality of access ports formed in the housing and structured to provide access to corresponding ones of the terminals, a reed switch disposed within the housing at a location proximate a corresponding one of the access ports, a communication line in electrical communication with the reed switch, a control connector in communication with the plurality of communication lines and outputting a control signal indicative of an open/closed state of the reed switch, and a member removably mounted on the housing and structured so that removal of the member is necessary to gain access to the terminals, the removable member having a magnet and a plurality of access port plugs structured for plugging respective ones of the access ports when the removable member is mounted, the magnet closing the reed switch when the removable member is mounted, where removal of the member opens the reed switch.

In various embodiments, an electric machine may have a removable member with a handle structured for simplifying a pulling/pushing of the removable member during the removal/mounting of the member from/to the housing. A sealing member may be provided for sealing the removable member to the housing.

The foregoing summary and the abstract of the disclosure do not limit the invention, which is instead defined by the attached claims.

### BRIEF DESCRIPTION OF THE DRAWING FIGURES

The above mentioned and other features will become more apparent and the invention will be better understood by reference to the following description of embodiments of the invention taken in conjunction with the accompanying drawing figures, wherein:

FIG. 1 is a schematic view of an exemplary electric vehicle;

FIG. 2 is a perspective view of a housing, showing the location of high voltage lines entering the housing and associated access ports, according to an exemplary embodiment;

FIG. 3 is another perspective view of the housing of FIG. 2;

FIG. 4 is a perspective view of a terminal block for securing one or more high voltage lines thereto, according to an exemplary embodiment;

FIG. 5 is a perspective view of an electric machine having a terminal block and a connector, according to an exemplary embodiment;

FIG. 6 is a perspective view of an electric machine having a terminal block, a connector, and an endplate, according to an exemplary embodiment;

FIG. 7 is an elevation view of an electric machine and associated high voltage and low voltage connections thereto, according to an exemplary embodiment;

FIG. 8 is a cross section view of an electric machine and associated high voltage and communication connections thereto, according to an exemplary embodiment;

FIG. 9 is a cross section view of an electric machine having a magnet-containing plug and a reed switch in a terminal block, and an associated high voltage connection, according to an exemplary embodiment;

FIG. 10 is a perspective view of a magnet-containing plug for being removably inserted into any of the access ports of FIG. 2, according to an exemplary embodiment;

FIG. 11 is a perspective view of a cover plate with three access port plugs, according to an exemplary embodiment;

FIG. 12 is a cross section view of the cover plate of FIG. 11, installed in a housing of an electric machine, according to an exemplary embodiment;

FIG. 13 is a schematic view of a low voltage circuit that includes a plurality of reed switches and a plurality of discrete resistances, according to an exemplary embodiment; and

FIG. 14 is a schematic view of a low voltage control circuit outputting a control signal for disconnecting high voltage being supplied to an electric machine, according to an exemplary embodiment.

Corresponding reference characters indicate corresponding parts throughout the several views. The illustrated embodiments are exemplary and are not intended to be exhaustive or to be construed as limiting the scope of the invention to the precise forms or applications disclosed.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of the present invention.

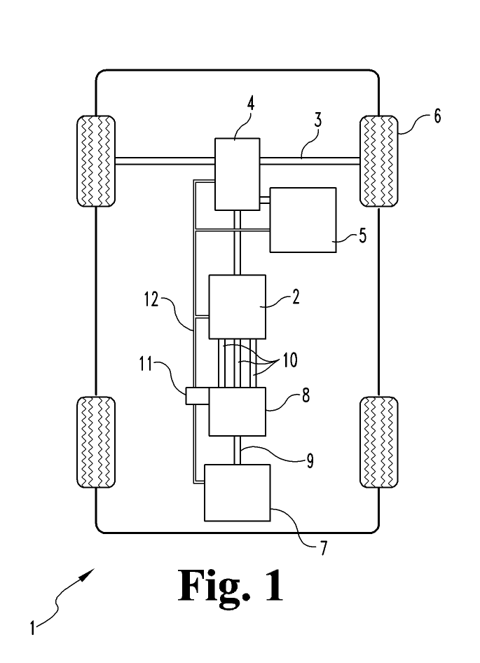

FIG. 1 shows a schematic view of an exemplary vehicle 1 with an electric machine 2 coupled to a drive axle 3 via transmission 4. An internal combustion type motor is also coupled to drive axle 3 via transmission 4. It is noted that, respecting various embodiments, vehicle 1 may be designed and built without transmission 4 (e.g., direct drive) and/or internal combustion type motor 5 (e.g., all-electric). When vehicle 1 is a hybrid, power is provided to drive axle 3 by electric machine 2, internal combustion motor 5, or some combination of the two. As used herein, an “electric vehicle” refers to any vehicle that includes an electric machine as part of its drive train. Wheels 6 are secured to distal ends of drive axle 3 and a second axle (not shown). A high voltage battery pack 7 outputs a DC high voltage to inverter 8 via DC power lines 9. Inverter 8 outputs a three-phase AC high voltage to electric machine 2 via three AC high voltage lines 10. Electrical ground potential is connected to electric machine 2 via a chassis (not shown) of vehicle 1. A controller 11 sends and receives data, such as by use of low voltage electrical signals in communication with the many operational and sensing devices of vehicle 1. Controller 11 may be formed as any number of individual and/or modular controllers. In this example, controller 11 sends and receives low voltage signals via communication lines 12.

Although the example of FIG. 1 shows only one electric machine 2, vehicle 1 may have any number of electric motors, generators, and motor/generators that receive either AC or DC power for producing mechanical power and/or electric power. For example, electric machine 2 may include a motor/generator (a “traction motor”) that acts as a motor in producing mechanical power for driving wheels 6 when needed, and that acts as a generator in producing a voltage for charging battery pack 7, such as by use of engine braking. In another example, vehicle 1 may have an electric machine 2 dedicated to providing drive for an individual wheel 6. As used herein, an electric motor may be used as a generator.

Similarly, battery pack 7 may include any number of individual battery cells arranged in any given configuration. For example, individual cells may be arranged in various locations of vehicle according to available space, temperature and safety considerations, and weight distribution for achieving desired vehicle performance specifications. Typically, individual cells are connected in series for obtaining a DC high voltage, although portions of battery pack 7 may be configured in parallel or some series/parallel combination, for example by use of a switching system. Individual battery cells may be lead acid, lithium-ion, nickel-metal, or another rechargeable type. Battery pack 7 may also include a fuel cell, a capacitor bank, or another voltage source. Battery pack 7 may be partitioned to provide a DC high voltage for conversion to AC high voltage in inverter 8, and to provide a DC low voltage for operation of lights, sound system, control and sensor circuitry, and other vehicle systems. DC low voltage circuitry may include one or more DC-DC converters.

By way of example, inverter 8 has three separate phase arms in parallel between positive and negative ones of DC power lines 9. Each phase arm contains switching elements and diodes controlled using pulse width modulation signals from controller 11. Intermediate points of the three phase arms are used for outputting AC high voltage on respective ones of the three AC power lines 10. When electric machine 2 is a traction motor, inverter 8 has a switching system for effecting bidirectional conversion of electrical power between electric machine 2 and battery pack 7. For example, inverter 8 converts DC battery voltage into three-phase AC high voltage being supplied to electric machine 2 for driving drive axle 3 with a specified torque. Electric machine 2 generates three-phase AC electric power and inverter 8 converts such AC electricity into DC power for charging battery pack 7, for example, during regenerative braking. In such a case, inverter 8 includes or accesses a battery charging circuit (not shown). Internal combustion motor 5 may also provide energy for charging battery pack 7. It is noted that some vehicle applications may use high voltage for powering a system other than a drive train, such as a high voltage electric compressor of an air conditioning system.

The DC high voltage, in applications such as a golf cart, may be as low as 48 volts, but for all-electric and hybrid type vehicles having a large number of battery cells, the DC high voltage on DC power lines 9 may be 200 to 1000 volts or more. After conversion by inverter 8, this may result in an AC high voltage on AC power lines 10 of 200 to 1000 volts or more. Some applications may utilize 3000 volts and 5000 amperes. Such high voltage is necessary for powering electric machine 2, but is dangerous and may result in severe injury or death if AC power lines 10 are touched. High voltage battery pack 7, and locations within vehicle 1 where power lines 9, 10 extend, may include high voltage warning labels, but these labels will not suffice as protection from injury if AC power lines 10 are touched. Labels also become worn and dirty over time, rendering them less effective. Further, many people will simply ignore warning labels. As the number of electric vehicles 1 on our roads becomes larger, more of these vehicles are involved in traffic mishaps and wind up in collision repair facilities. More electric vehicles 1 wind up being repaired, serviced, and maintained by untrained personnel who may not follow OEM servicing procedures. Even trained service personnel working in proximity to high voltages may err by wearing metal jewelry, by failing to wear insulating gloves and clothing, or by failing to check whether a power line is “hot” by using a volt meter. Electric vehicle 1 includes electrical disconnects (not shown) that provide additional safety for personnel by controllably switching the connection of electric power to electric machine 2. Controller 11 includes firmware or the like for controlling the disconnecting of AC high voltage from AC power lines 10 in the occurrence of a predetermined sensor state or other vehicle event.

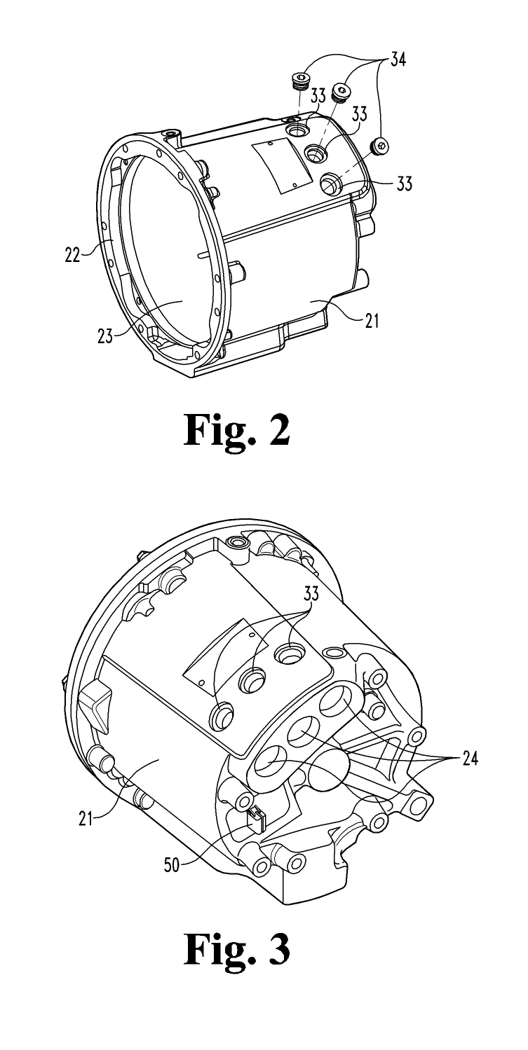

FIG. 2 shows an exterior housing 21 for holding electric machine 2. Housing 21 may be formed by a casting operation and has a connecting flange portion 22 for mating engagement with a transmission 4. Housing 21 has a generally cylindrical interior portion 23 for receiving electric machine 2, associated wiring and connections, and other apparatus related to a drive train. Three AC power lines 10 are installed in respective ones of the three high voltage cable entry ports 24 shown in FIG. 3. Depending on required current carrying capacity, each AC power line 10 may be an insulated cable of American Wire Gauge (AWG) #8 to #0000 standard circular cross section copper wire. Three high voltage cable connection access ports 33 are formed in housing 21 to allow service professionals to access the connection of AC power lines 10 to electric machine 2, such as when using a screwdriver to fasten AC power lines 10 to associated connection points inside housing 21. Access port plugs 34 may be inserted into connection access ports 33 after service work or installation has been performed. Battery pack 7 is not connected when vehicle 1 is being assembled at a factory. After battery pack 7 has been installed, controller 11 prevents “live” voltages from being present on AC power lines 10 when unqualified service persons, who may not be trained in safety and protection respecting contact with high voltages, attempt to enter connection access ports 33, as discussed further below.

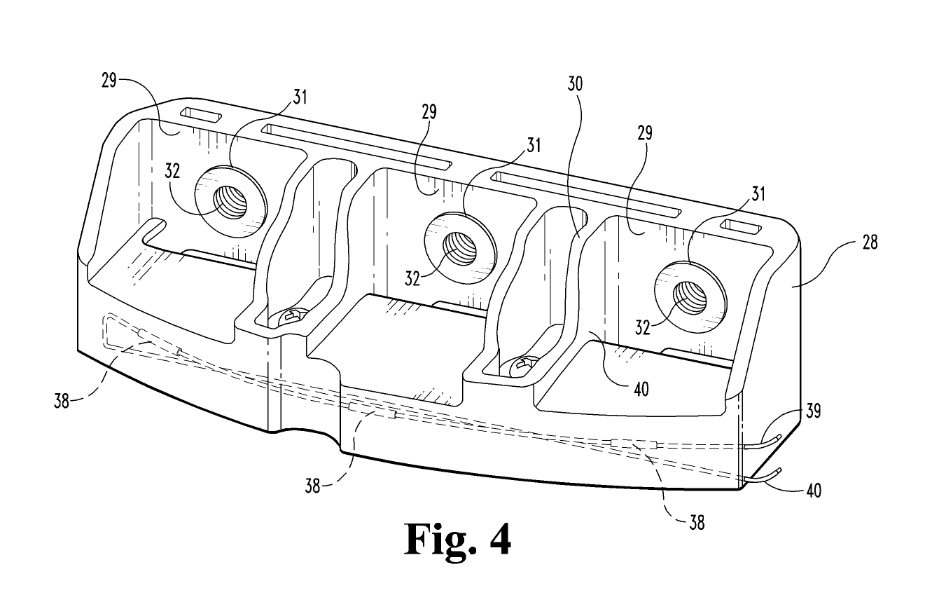

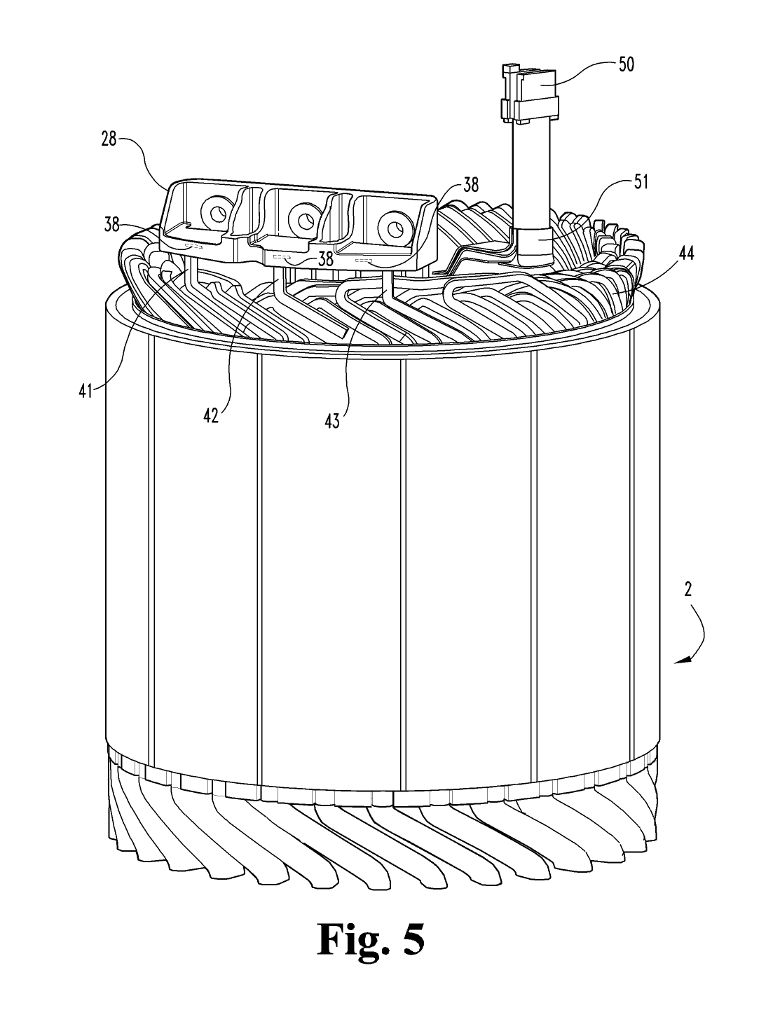

As shown in FIG. 4, a terminal block 28 has an insulating portion 30 for partitioning cable receiving portions 29 from one another and for electrically insulating high voltage from various conductive portions of electric machine 2. Terminal block 28 includes three metal inserts 31 for attaching respective ones of AC power lines 10 thereto. Any appropriate connection system may be used for securely attaching AC power lines 10 to metal inserts 31. As shown in FIG. 5, terminal block 28 is positioned at an axial end of electric machine 2. Each metal insert 31 is electrically connected to a respective end of the three phase coils 41, 42, 43 of a stator 44. When electric machine 2 is installed within interior portion 23 of exterior housing 21, the three cable receiving portions 29 of terminal block 28 are aligned with respective ones of cable entry ports 24 of housing 21. In this manner, AC power lines 10 are fed through cable entry ports 24 to terminal block 28, and then electrically connected to the respective ones of phase coils 41, 42, 43 at coil ends thereof. The other three coil ends of phase coils 41, 42, 43, for example, may be connected to one another at a neutral point within stator 44.

A cover plate (not shown) has conventionally been fastened to housing 21 to cover connection access ports 33 after installation of AC power lines 10. When the cover plate is removed, connection access ports 33 allow trained service professionals to access the high voltage electrical connections to electric machine 2, such as for performing repairs. However, such access should be prevented with respect to unqualified persons who may not be trained in safety and protection respecting contact with high voltages.

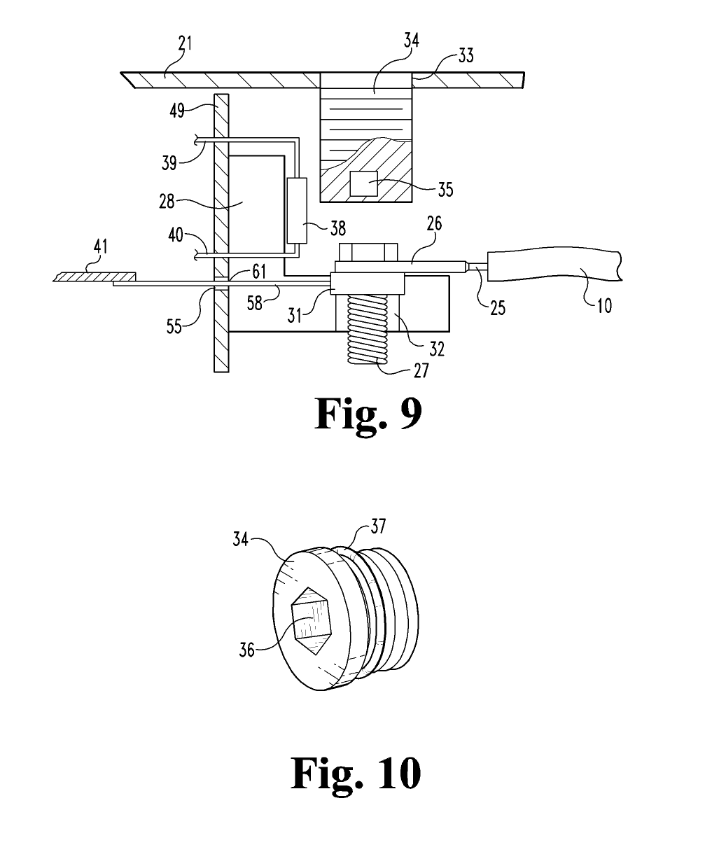

As shown in FIG. 10, a connection access port plug 34 has a generally cylindrical shape and is typically formed of non-conductive, high strength, temperature-resistant resin material that completely encloses a magnet 35, as shown in FIG. 9. Various other materials such as aluminum or steel may be used in forming access port plug 34. In an exemplary alternative embodiment, an access port plug may be metallic and may have one or more magnets adhered to an external surface thereof. Access port plug 34 may be formed with threads that mate with corresponding threaded interior portions of access ports 33, or access port plugs 34 may be formed in any other appropriate manner for insertion into access ports 33. A plurality of access port plugs 34 are installed into respective ones of connection access ports 33 after the installation of AC power lines 10. A tool-receiving cavity 36 is formed in a top end surface of access port plug 34, allowing a service professional to insert a corresponding tool (not shown) into cavity 36, and to then pull/push or turn the tool for installing/removing connection port plug 34 to/from one of connection access ports 33. An O-ring type seal 37 may be installed to snugly fit around the circumference of the outside wall of access port plug 34. For example, O-ring 37 may be secured in a circumferential groove formed in such outside wall of access port plug 34. When installed, access port plug 34 thereby seals the corresponding high voltage connection point of electric machine 2 against outside contamination and/or interior oil leakage. Various other sealing structures, materials, and methods may alternatively be incorporated into access port plug 34.

As shown in FIG. 4, three reed switches 38 are positioned inside terminal block 28 adjacent respective ones of connection access ports 33. Reed switches 38 typically each have a pair of electrical contacts (not shown). In an exemplary series loop configuration, a low voltage circuit is formed by connecting one contact of a first one of reed switches 38 to one contact of a second one of reed switches 38, connecting the other contact of second reed switch 38 to one of the contacts of a third one of reed switches 38, connecting the other contact of first reed switch 38 to a first low voltage control wire 39, and connecting the other contact of third reed switch 38 to a second low voltage control wire 40. Control wires 39, 40 are connected to communicate with controller 11 which, for example, monitors a voltage between control wires 39 and 40. When the three connection port plugs 34 are installed in connection access ports 33, the three magnets 35 of connection port plugs 34 activate respective ones of the three reed switches 38, causing reed switches 38 to close, thereby completing the series loop circuit between wires 39 and 40. Reed switches 38 and the above-described low voltage circuit may be molded within terminal block 28 so that only portions of control wires 39, 40 extend from terminal block 28 for connection to a control connector 50. When any of connection port plugs 34 is removed, the corresponding magnet 35 is thereby brought out of activation range of the respective one of reed switches 38, which opens such reed switch 38 and communicates a voltage change to controller 11 via low voltage control wires 39, 40, whereupon controller 11 causes disconnection of AC high voltage to AC power lines 10. Three metal inserts 31 are provided in terminal block 28 for receiving an electrical connection to respective ones of AC power lines 11. The remainder of terminal block 28 is preferably formed of insulating material 30, including partitions that separate cable receiving portions 29 from one another. Threaded portions 32 may be formed in each metal insert 31 for receiving a bolt or other fastener that secures a respective one of AC power lines 10.

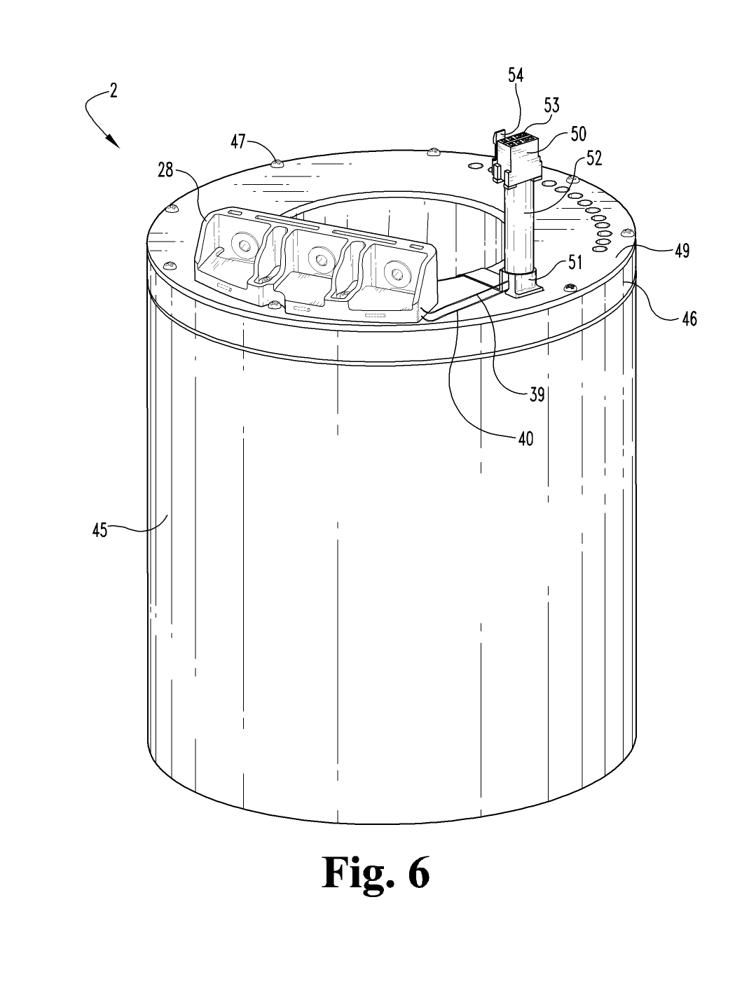

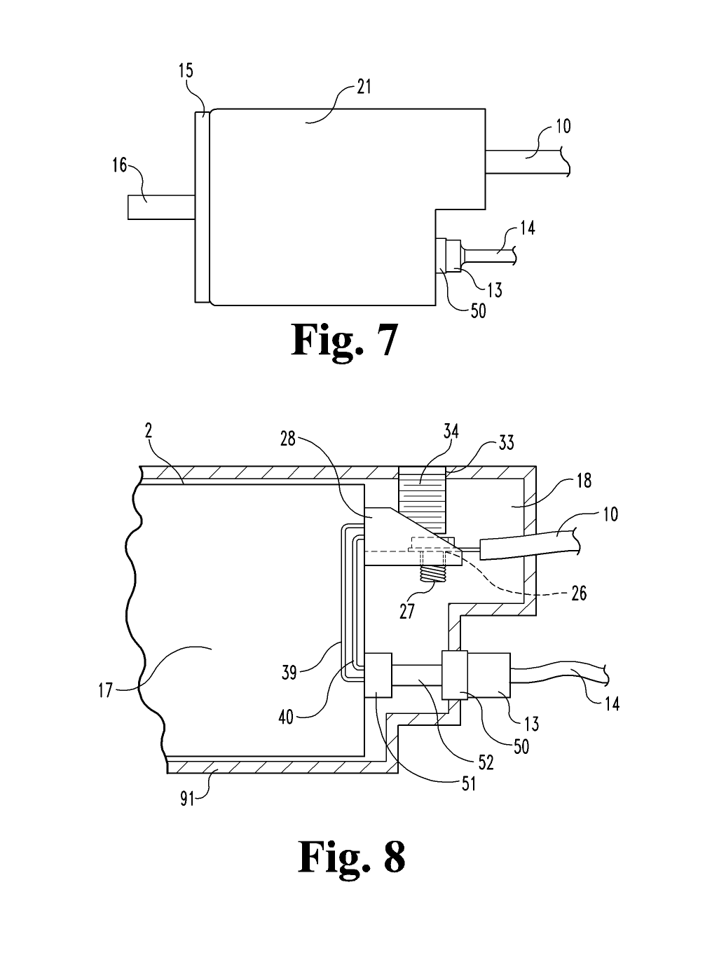

As shown in FIG. 6, electric machine 2 has an essentially cylindrical protective housing 45 for covering internal components and for providing a support structure. An annular rear end plate 46 has the same diameter as protective housing 45 and is placed to abut end face 48 of protective cover 45. An annular rear cover 49 also has the same diameter as protective housing 45 and is secured thereto by use of threaded fasteners 47 which pass through respective passages (not shown) of rear end plate 46 to engage respective threaded receptacles (not shown) formed along the circumference of end face 48 of protective housing 45. Rear cover 49 includes holes and other mounting structure (not shown) such as threaded fasteners, for attaching terminal block 28 thereto and for positioning conductive portions of the respective connections of metal inserts 31 of terminal block 28 with phase coils 41, 42, 43 to be spaced away from contact with any other conductive surfaces. Low voltage control wires are fed from terminal block 28 to routing member 51, to communication cable 52, and to control connector 50. Routing member 51 receives any number of wires or other communication means from various sensors of electric machine 2, and transfers such wires/signals to control connector 50 via cable 52. Routing member 51 may include a sealing structure and/or strain relief to provide protection and structural support for wires passing through rear cover 49, and to prevent contamination of electric machine 2. Routing member 51 may simply pass wires therethrough, or it may be formed as one or more multi-conductor connectors with a sealing structure. Communication cable 52 has a heat and corrosion resistant outer insulation jacket and may be sealingly joined to both routing member 51 and control connector 50. Control connector 50 has any number of signal contacts 53, a keyed structure, and one or more prongs 54 or the like for securing control connector 50 to external housing 21. The keyed structure and contacts 53 of connector 50 are formed to be securely mated with corresponding parts of an external communication connector 13, shown in FIG. 7. Communication connector 13 communicates with controller 11 via communication lines 14. FIG. 7 shows an exemplary assembled housing 21 having a housing end plate 15 formed for mating attachment to flange 22. An output shaft 16 transfers mechanical power from electric machine 2 to drive axle 3.

FIG. 8 provides a cross sectional view of the connections of AC power lines 10 and communication lines 14 to electric machine 2. Low voltage control wires 39, 40 may be routed from routing member 51 to reed switches 38 via an interior portion 17 of electric machine 2, whereby low voltage wires 39, 40 are protected from being damaged. AC power lines 10 are fed through cable entry ports 24 of housing 91. High voltage cable entry ports 24 may include sealing members (not shown), for example rubber grommets or other appropriate structure, for preventing contamination of interior space 18 after AC power lines 10 have been installed. Ring terminals 26 are affixed to bare wire ends of respective ones of AC power lines 10 and then secured to respective ones of metal inserts 31. For example, bolts 27 may be inserted into ring terminals 26 and then secured to metal inserts 31 by tightening bolts 27 into threaded interior portions 32. Wire terminal 26 may include an insulator that minimizes exposure of high voltage and that adds structural integrity to a given wire termination. Any suitable wire terminal may be used, or AC power lines 10 may alternatively be securely connected to electric machine 2 without use of wire terminals, such as by use of set screws. Electric machine 2 may be installed in housing 91 so that access ports 33 formed in housing 21 are concentric with bolts 27 and threaded portions 32 of respective cable receiving portions 29 of terminal block 28, or they may be offset as shown. High voltage cable entry ports 24 may include sealing members (not shown), for example rubber grommets fitted around each of AC power lines 10 or other appropriate structure, for preventing contamination of interior space 18 after AC power lines 10 have been installed. Communication lines 14 include wires and other communications media that transfer signals between controller 11 and various sensors/controls of electric machine 2, for example those for sensing temperatures, electrical currents, electrical voltages, rotational speeds, switching status, logic states, etc., and those for effecting switching or other control functions.

FIG. 9 provides a cross sectional view showing an exemplary positioning of magnet 35 with respect to reed switch 38. Reed switch 38 is activated when the magnetic field of magnet 35 is in proximity thereto. In the example discussed above, three reed switches 38 of a series low voltage circuit each have normally open contacts that close when reed switch 38 activates. Reed switch 38 is hermetically sealed and has corrosion-resistant leads, allowing reed switch 38 to be exposed on an exterior portion of terminal block 28 and to be positioned at any location within the range of pull-in sensitivity to a given magnet 35. Reed switch 28 may be completely enclosed within terminal block 28 to prevent damage thereto. When magnet 35 is disposed along a central longitudinal axis of plug 34, the location of reed switch 38 may be chosen independently of the angular rotation of plug 34. In a case where magnet 35 is disposed radially outward of such center axis, it may be necessary for an installer to orient plug 35 so that the corresponding magnetic field actuates reed switch 38, whereby the requirement for such orientation may effect an additional safety step. Metal inserts 31 may be formed with threaded interior portions 32, so that bolts 27 may be inserted into ring terminals 26 and then secured to metal inserts 31 by tightening bolts 27 into threaded interior portions 32. As noted above, metal inserts 31 may alternatively be formed as set screw type connectors where, for example, metal insert 31 is formed as a split bolt that receives a bare high voltage cable 25 that is then secured to metal insert 31 by a bolt 27 formed as a set screw. Each metal insert 31 of terminal block 28 has an integrally formed extending portion 58 that transfers high voltage electrical power to one of phase coils 41, 42, 43. Extending portion 58 extends orthogonally with respect to terminal block mounting surface 60 and exits terminal block 28 at a high voltage power location 61.

An annular high voltage passage 55 is formed in rear cover 49 (FIG. 9) at each location that corresponds to a respective one of three high voltage power locations 61. Annular high voltage passage 55 provides an opening around extending portion 58 to prevent extending portion 58 from coming into contact with rear cover 49. An insulating insert (not shown) may be provided within high voltage passage 55. Each of the three extending portions 58 is welded to a respective one of phase coils 41, 42, 43 (FIG. 5), or is alternatively fixedly coupled thereto by any other suitable means. For example, three conductor bars or cables (not shown) may be welded to respective ones of phase coils 41, 42, 43 and three ring terminals 26, or the like, may be secured to the other respective ends of such conductor bars or cables, so that such ring terminals 26 may be bolted to respective ones of metal inserts 31 at a same time as the connecting of AC power lines 10. Depending on required current carrying capacity, each AC power line 10 is preferably an insulated cable of American Wire Gauge (AWG) #8 to #0000 standard circular cross section copper wire 25, fixedly terminating in a ring type electrical wire terminal 26. Wire terminal 26 may include an insulator that minimizes exposure of high voltage and that adds structural integrity to a given wire termination. Any suitable wire terminal may be used, or AC power lines 10 may alternatively be securely connected to electric machine 2 without use of any wire terminals, such as by use of set screws. Various other structures may alternatively be used for electrically connecting phase coils 41, 42, 43 to respective ones of metal inserts 31.

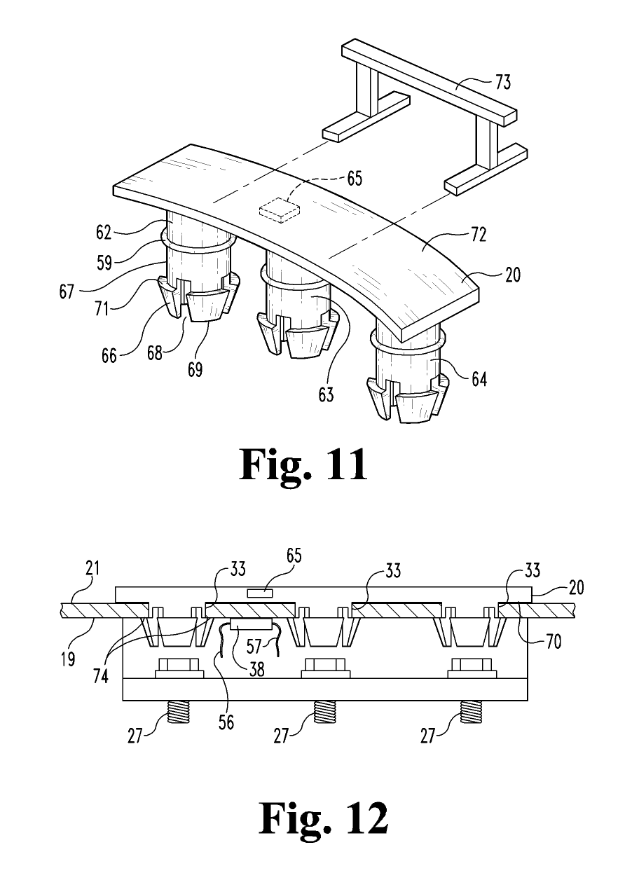

FIGS. 11 and 12 show an example of a cover plate 20 integrally formed to have three access port plug members 62, 63, 64. Each access port plug member 62, 63, 64 has an essentially cylindrical body portion 67 that extends away from a bottom surface 70 of cover plate 20 to form a plurality of prongs 66 structured for allowing plug members 62, 63, 64 to snap into respective ones of access ports 33 when cover plate 20 is fully installed on housing 21. Prongs 66 are circumferentially spaced apart from one another to facilitate free movement of prongs 66 during the installation/removal of plug members 62, 63, 64 respecting access ports 33. For example, a space 68 may be defined between adjacent ones of prongs 66 and may extend from a distal end 69 of plug 66 to a location along cylindrical body portion 67. Each prong 66 has an engagement surface 71, and all engagement surfaces 71 of access port plug members 62, 63, 64 are coplanar with one another so that all engagement surfaces 71 are flush with respective mating portions 74 of an interior surface 19 of housing 21 when cover plate 20 is installed on housing 21. An outward facing surface of each prong 66 is tapered from distal end 69 to engagement surface 71, allowing each prong 66 to bend inwardly during installation and then snap back outwardly into engagement. A magnet 65 is positioned within cover plate 20. Cover plate 20 may be formed of high-strength, flexible plastic to facilitate molding magnet 65 therewithin and to facilitate the installation/removal of plug members 62, 63, 64. A single reed switch 38 is positioned at a location of terminal block 28, so that magnet 65 is in proximity to, and thereby actuates, reed switch 38 when cover plate 20 is fully installed. Such location is preferably chosen to avoid the possibility of damage to reed switch 38 and/or leads 56, 57, for example when tools are inserted into any of access ports 33 during a servicing operation after cover plate 20 has been removed. Reed switch 38 may either be molded within terminal block 28 or secured to an external portion thereof. Alternative cover plates are disclosed by Chamberlin, et al. in U.S. patent application Ser. No. ______, entitled “Safety Cover With Integrated Magnet For Reed Switch,” filed on the same day as the present application and incorporated herein by reference in its entirety.

The actuation of reed switch 38 electrically connects leads 56, 57 to one another, thereby completing a low voltage circuit in communication with controller 11, which correspondingly enables high voltage to be supplied to AC power lines 10. Cover plate 20 may be formed to allow a removal tool (not shown) to be inserted for disengaging prongs 66 during the removal of cover plate 20. However, the respective positions of magnet 65 and reed switch 38 should be chosen to prevent any possibility that a service access could be made without first moving magnet 65 for de-activating reed switch 38. A handle 73 may be provided for allowing a service professional to grasp cover plate 20 during the installation/removal. Handle 73 may be formed integrally with cover plate 20 or alternatively may be secured thereto by use of fasteners such as threaded screws (not shown). Any of access port plug members 62, 63, 64 may be formed without prongs 66. For example, when only a middle one of access port plug members 62, 63, 64 is formed with prongs 66, an end one of access port plug members 62, 63, 64 may be lifted by a service professional, thereby moving magnet 65 and de-activating reed switch 38, which causes controller 11 to remove AC high voltage from power lines 10. A reset function of controller 11 prevents accidentally re-activating reed switch 38 and/or accidentally returning AC high voltage to power lines 10 after a first de-activation of reed switch 38. When AC power has been removed, the service professional is then able to insert the prong disengagement tool for removing the center one of one of access port plug members 62, 63, 64 and lifting cover plate 20 away from housing 21.

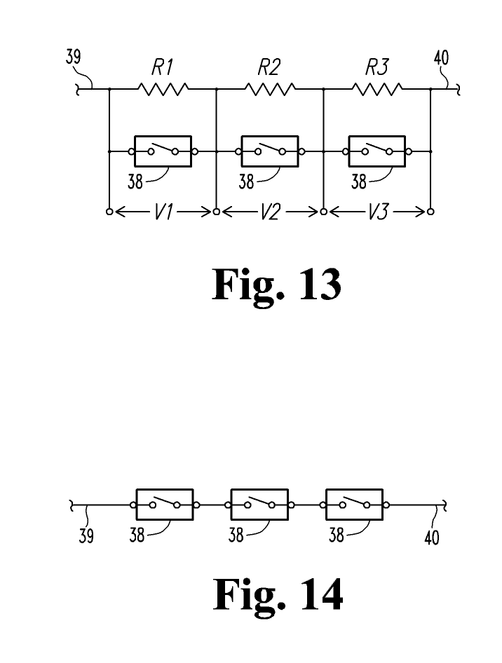

In an exemplary configuration of FIG. 13, three discrete resistances R1, R2, R3 are separately connected to at least one contact of a respective one of the three reed switches 38. For example, when separate parallel low voltage circuits having different discrete resistance values are provided for respective ones of the three reed switches 38, controller 11 may be configured to monitor voltages V1, V2, V3 that correspond to such resistances R1, R2, R3. In such a case, controller 11 is able to verify that all of the correct components are installed in the appropriate locations and in the proper configuration. For example, when a voltage across low voltage control wires 39, 40 is zero, controller 11 may determine that three reed switches 38 are closed and a safe condition exists for enabling AC high voltage on AC power lines 10; when a voltage between control wire 39 and intermediate contact 76 corresponds to a predetermined range of voltage V1, controller 11 may determine that a reed switch 38 corresponding to resistance R1 has opened; when a voltage between intermediate contact 76 and intermediate contact 77 corresponds to a predetermined range of voltage V2, controller 11 may determine that a reed switch 38 corresponding to resistance R2 has opened; etc. When one of the discrete resistances is outside a tolerance range, controller 11 may determine that an interlock system failure has occurred for a specific reed switch 38 by detecting an open low voltage circuit, controller 11 may determine that a low voltage supply (e.g., a connection to an ancillary 12 volt battery) needs maintenance when voltages of a number of monitored low voltage circuits of an interlock system are low, or controller 11 may disable voltage to AC power lines 10 when an open circuit is detected for one or more of reed switches 38, etc. Various series/parallel configurations are envisioned for monitoring a status of low voltage circuit(s) that include reed switches 38. FIG. 14 shows an exemplary interlock low voltage circuit that may be used for embodiments such as those shown in FIGS. 4-6. For example, when any of reed switches 38 is opened, such is communicated to a controller 11 as a control signal via low voltage control lines 39, 40.

It is noted that controller 11 may be structured for disabling an interlock low voltage circuit such as that shown by example in FIG. 14. Such a disabling may be employed, for example, during dynamic testing of an electric vehicle 1 when a battery pack 7 and/or inverter 8 have been disconnected and electric machine 2 and/or the integrity of AC power lines 10 are being performance tested by a service professional. In such a case, for example, various modifications may be made in a low voltage circuit or additional hidden magnets and associated additional reed switches may be utilized, for causing controller 11 to enter ones of predetermined service modes.

It will be appreciated by one skilled in the art that an electric vehicle 1 may include any number of separate engines and generators that work independently or in cooperation with one another. Electric vehicle 1 may be structured for operation in a number of different operative modes, whereby associated mechanical, electrical, pneumatic, hydraulic, chemical, and other systems have a dynamic arrangement for adapting to a chosen mode. It is necessary for controller 11 to be structured for assuring safe servicing and repair so, for example, when a reed switch 38 has been momentarily opened, controller 11 may include servicing modes that allow a service professional to safely return the AC high voltage to AC power lines 10 after properly re-activating a given reed switch 38, without having to slide out from under a vehicle. In such a case, controller 11 may quickly determine a proper state of magnet placement respecting power lines to a given electric machine 2 and safely return power thereto.

While various embodiments have been described in detail, further modifications and adaptations may occur to those skilled in the art. However, it is to be expressly understood that such modifications and adaptations are within the spirit and scope of the present invention.

What is claimed is:

1. A vehicular subsystem for use in a vehicle having at least one wheel, the subsystem comprising:
a housing;
an electric machine operably coupled with the wheel and positioned within the housing;
a power source that provides electric power to the electric machine via at least one high voltage line;
a connection disposed within the housing and connecting the high voltage line with the electric machine;
a controller controllably coupled to the power source;
a reed switch positioned within the housing proximate the high voltage line connection;
a member removably mounted on the housing and structured so that removal of the member is necessary to gain access to the high voltage line connection, the member comprising a magnet; and
at least one low voltage communication line extending from the reed switch to the controller;
wherein removal of the member from the housing opens the reed switch, mounting of the member to the housing closes the reed switch, and wherein the controller causes disconnection of the electric power when the member is removed from the housing.

2. The vehicular subsystem of claim 1, further comprising a terminal block, wherein the reed switch is mounted on the terminal block.

3. The vehicular subsystem of claim 2, wherein the removable member is a threaded plug and the magnet is molded within the threaded plug.

4. The vehicular subsystem of claim 2, wherein the at least one high voltage line comprises a plurality of high voltage lines, and wherein the subsystem has corresponding pluralities of the connection, the reed switch, and the removable member, and wherein removal of any of the plurality of removable members terminates the provision of electric power to all of the plurality of high voltage lines.

5. An electric machine, comprising:
a housing;
an electric motor disposed in the housing;
a terminal block disposed within an interior portion of the housing and having at least one terminal structured for securing a corresponding at least one high voltage cable thereto;
at least one access port formed in the housing and structured to provide access to the terminal;
at least one reed switch disposed within the housing at a location proximate the access port;
a control connector mounted on the housing and in communication with the reed switch;
at least one communication line in electrical communication with the reed switch; and
at least one access port plug having a magnet, the access port plug closing the reed switch when the access port plug is installed in the access port, the access port plug opening the reed switch when removed from the access port;
wherein the communication line is in communication with the control connector, whereby an external controller can be placed in communication with the reed switch.

6. The electric machine of claim 5, further comprising a terminal block, wherein the reed switch is mounted on the terminal block.

7. The electric machine of claim 6, wherein the removable member is a threaded plug and the magnet is molded within the threaded plug.

8. The electric machine of claim 6, wherein the terminal block includes a plurality of the terminals for securing a corresponding plurality of the high voltage cables thereto, and wherein the electric machine includes, in correspondence, a plurality of the access ports, a plurality of the reed switches, and a plurality of the removable access port plugs.

9. The electric machine of claim 6, wherein the terminal block includes a plurality of the terminals for securing a corresponding plurality of the high voltage cables thereto, and wherein the electric machine includes, in correspondence, a plurality of the access ports and a plurality of the removable access port plugs.

10. The electric machine of claim 8, wherein the communication line is in series with each of the plurality of reed switches.

11. The electric machine of claim 8, wherein the control connector comprises a control switch structured for bypassing a portion of the communication line in series with the plurality of reed switches.

12. The electric machine of claim 8, wherein the communication line comprises a plurality of discrete resistances respectively disposed in parallel with ones of the plurality of reed switches, and wherein the discrete resistances are disposed in series respecting one another, whereby the control connector communicates a voltage related to such resistance to the controller.

13. The electric machine of claim 5, wherein the control connector is in series electrical connection with the communication line, and wherein removal of the electric motor from the housing causes the control connector to open the series electrical connection.

14. The electric machine of claim 5, wherein the communication line comprises a discrete resistance in direct electrical connection with the reed switch, and wherein the control connector outputs a voltage of the communication line to the controller, such voltage being related to the discrete resistance.

15. The electric machine of claim 5, wherein the access port plug is formed as one of a threaded plug and a snap-in type plug having a at least one prong that bends when the access port plug is being installed/removed.

16. The electric machine of claim 5, wherein the access port plug comprises a sealing member for sealing the access port plug to the access port.

17. The electric machine of claim 8, wherein a plurality of the communication lines are in electrical communication with the reed switches, such electrical communication being configured as one of a parallel and series/parallel architecture respecting the plurality of communication lines and the plurality of contacts, and wherein the control connector is in communication with the plurality of communication lines and outputs a control signal indicative of an open/closed state of the reed switches.

18. An electric machine, comprising:
a housing;
an electric motor disposed in the housing;
a terminal block disposed within the housing and having a plurality of terminals structured for securing a corresponding plurality of high voltage cables thereto;
a plurality of access ports formed in the housing and structured to provide access to respective ones of the terminals;
a reed switch disposed within the housing at a location proximate a corresponding one of the access ports;
a communication line in electrical communication with the reed switch;
a control connector in communication with the communication line and outputting a control signal indicative of an open/closed state of the reed switch; and
a unitary member removably mounted on the housing and structured so that removal of the member is necessary to gain access to the terminals, the removable member comprising a magnet and a plurality of access port plugs structured for plugging respective ones of the access ports when the removable member is mounted, the magnet closing the reed switch when the removable member is mounted;
wherein removal of the removable member opens the reed switch.

19. The electric machine of claim 18, wherein the removable member further comprises a handle structured for assisting a user when pulling/pushing the removable member during the removal/mounting.

20. The electric machine of claim 18, wherein at least a portion of the access port plugs are formed as one of threaded plugs and snap-in type plugs each having a at least one prong that bends when the respective access port plug is being installed/removed.
